(19) United States
(12) Patent Application Publication
(10) Pub. No.: US 2025/0154027 A1
(43) Pub. Date: May 15, 2025

(54) Desalination Via Graphene and Heliostat

(71) Applicant: Nant Holdings IP, LLC, Culver City, CA (US)

(72) Inventor: Patrick Soon-Shiong, Culver City, CA (US)

(73) Assignee: Nant Holdings IP, LLC, Culver City, CA (US)

(21) Appl. No.: 18/942,032

(22) Filed: Nov. 8, 2024

Related U.S. Application Data
(60) Provisional application No. 63/597,920, filed on Nov. 10, 2023.

(51) Int. Cl. C02F 1/14; B01D 1/00; B01D 1/18; B01D 1/20; B01D 53/04; B01D 53/26; C02F 1/04; C02F 1/12; C02F 1/44; C02F 101/12; C02F 103/08; C25B 1/04; C25B 9/65; C25B 15/08

(52) U.S. Cl. CPC C02F 1/14; B01D 1/0035; B01D 1/18; B01D 1/20; B01D 53/0438; B01D 53/261; C02F 1/043; C02F 1/12; C02F 1/44; C25B 1/04; C25B 9/65; C25B 15/085; B01D 2253/204; B01D 2257/80; B01D 2259/40088; C02F 2101/12; C02F 2103/08

(57) ABSTRACT

A desalination plant includes a primary desalination reactor that is fluidly coupled to a saltwater source by a saltwater transfer conduit, wherein the saltwater transfer conduit has a luminal surface that comprises a super-hydrophobic coating to thereby reduce or even entirely avoid fouling of the transfer conduit. A heliostat is thermally coupled to the primary desalination reactor such that the heliostat provides thermal energy to generate from saltwater a water vapor stream and a solid salt precipitate. In most embodiments, the primary desalination reactor allow continuous feeding of the saltwater into and continuous withdrawal of the water vapor and the solid salt precipitate from the primary desalination reactor.

This application claims priority to our copending US provisional patent application with the Ser. No. 63/597,920, filed Nov. 10, 2023, which is incorporated by reference herein.

### FIELD OF THE INVENTION

The field of the invention is plant configuration and methods of saltwater desalination, especially as it relates to continuous seawater desalination using a heliostat that provides directly or indirectly thermal energy to the saltwater, and wherein the saltwater is conveyed over considerable distances through a conduit with a superhydrophobic coating.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Desalination of saline water, and especially seawater, is generally believed to be one of the most sustainable solutions to provide potable water, and seawater is available to many developing countries in Africa, the Pacific Asia areas, and countries in the Middle East and Latin America. To reduce salinity, saline water is typically separated into two parts: one with a low concentration of dissolved salts (fresh water), and the other with a much higher concentration of dissolved salts (brine concentrate). Such separation can be done using various technologies, and among other options reverse osmosis has become a conceptually simple yet effective method. Unfortunately, desalination of salty water/seawater by reverse osmosis is expensive, mostly because of the energy required. Similarly, numerous other technologies require substantial amounts of energy such as thermal (multi stage flash) distillation or electro-dialysis, and these techniques may cause air pollution due to the large consumption of energy derived from fossil fuels. In addition, such processes will often not recover the salt that was removed, leaving highly concentrated brines.

Avoiding concentrated brines is possible by complete separation of salt from saltwater, which can be achieved by evaporation-based processes. However, evaporation of water at atmospheric pressure requires large amounts of energy to raise the water temperature to the boiling point. This problem can be overcome by evaporation of water under reduced pressure where evaporation occurs at temperatures well below the atmospheric pressure boiling point. Notably, water evaporation under reduced pressure is energy efficient and can often be driven by low-grade thermal energy sources such as solar heat or process waste heat. Unfortunately, while the evaporation under reduced pressure will accelerate the evaporation rate, potential freezing problems will occur, and supplemental heat is therefore required. Moreover, where direct solar radiation is used for heat and vacuum generation, the production rate of pure water can be around 15 kg/m²/day, which does not readily scale for larger operations.

To increase heat input, heliostats can be used for collection of solar energy to power a solar distillation cell (see e.g., International Journal of Chemical Engineering Volume 2017, Article ID 5924173). However, co-location of desalination of saltwater and heliostats is often difficult as most coastal locations will not have a solar profile desired for operation of a heliostat, or conversely, as most locations desirable for operation of a heliostat will lack a steady supply of seawater.

Thus, even though various compositions and methods of desalination are known in the art, all or almost all of them suffer from several drawbacks, particularly where desalination should be performed in a continuous process using heliostat and where the heliostat is remote from the source of seawater. Therefore, there remains a need for improved plants and methods for desalination using heliostats.

### SUMMARY OF THE INVENTION

The inventive subject matter is directed to various desalination plant configuration and methods in which saltwater is desalinated using a heliostat and a primary desalination reactor that receives the saltwater from a typically remote source via saltwater transfer conduit that has a luminal surface with a super-hydrophobic coating to so reduce or avoid microbial fouling, water borne contamination, and even rust. Most preferably, the desalination plant will be configured to allow continuous feed of saltwater and continuous production of a solid salt product and substantially pure water having residual salt of equal or less than 500 ppm total dissolved solids.

In one aspect of the inventive subject matter, the inventor contemplates a desalination plant that comprises a primary desalination reactor that is fluidly coupled to a saltwater source (e.g., seawater source or a geothermic brine source) by a saltwater transfer conduit. In particularly preferred embodiments, the saltwater transfer conduit has a luminal surface that comprises a super-hydrophobic coating to so reduce or avoid microbial fouling and other water borne contamination. A heliostat is thermally coupled to the primary desalination reactor to provide sufficient thermal energy to generate water vapor and a solid salt precipitate from the saltwater. In further preferred embodiments, the primary desalination reactor allows continuous feeding of the saltwater into and continuous withdrawal of the water vapor and the solid salt precipitate from the primary desalination reactor.

In further embodiments, the saltwater source is lithium-rich. Moreover, the solid salt precipitate in some embodiments may comprise a lithium salt.

Most typically, the primary desalination reactor will comprise a distillation unit, a spray-drying unit, or a membrane filtration unit. Therefore, where the primary desalination reactor will produce a concentrated brine, the primary desalination reactor may further comprise (or be coupled to) a brine desiccation unit (e.g., via spray or batch drying) that desiccates the brine to so produce the solid salt precipitate.

For example, in some embodiments, the heliostat is configured to provide light energy as the thermal energy directly to the saltwater while in other embodiments the heliostat is configured to provide heat from a heat transfer medium as the thermal energy to the saltwater. In such case, the heat transfer medium was previously heated by light collected by the heliostat. In still other embodiments, the heliostat is configured to provide heat from a heated air stream as the thermal energy. In such case, the heated air stream was previously heated by light collected by the heliostat or by a heat transfer medium that was previously heated by light collected by the heliostat.

Moreover, it is contemplated that the heliostat may produce the water vapor at ambient pressure or at elevated pressure (e.g., at least 5 bar). It is further preferred (but not necessary) that the heliostat may be coupled to a condenser that receives and condenses the water vapor. As will also be appreciated, the primary desalination reactor may be co-located with, or a significant distance from (e.g., at least 1 or at least 5 or at least 10 kilometer) the saltwater source.

In especially contemplated aspects, the super-hydrophobic coating will effect a contact angle to water of at least 140°, or at least 150°, or at least 155°. Therefore, it is contemplated that the super-hydrophobic coating may include graphene or a chemically modified graphene. For example, the super-hydrophobic coating may comprise graphene in admixture with a resin or polymer, or the super-hydrophobic coating may comprise graphene with intercalated metal oxide nanoparticles. In still further examples, the super-hydrophobic coating may comprise chemically modified graphene that may include graphene oxide derivatized with a hydrophobic substituent.

Therefore, and depending on the type of material, it should be appreciated that the super-hydrophobic coating may be applied to the luminal surface as a paint, may be applied to the luminal surface as a laminate, or that the super-hydrophobic coating may be applied to the luminal surface by chemical vapor deposition or plasma deposition.

Additionally, it is contemplated that the desalination plant may further include a solids reduction unit fluidly coupled between the saltwater source and the primary desalination reactor, and exemplary solids reduction unit may be configured as a basket filter, a hydrocyclone, a flow-through centrifuge, a Tesla valve, or a cross flow filtration unit. Likewise, contemplated desalination plants may further include a sterilization unit that is fluidly coupled between the saltwater source and the primary desalination reactor, and suitable sterilization unit will include an electrochlorination unit, an ozone generator, and/or a UV sterilization unit (which may receive the UV light from the heliostat). Moreover, it is contemplated that the desalination plant may further include a metal oxide framework unit that is fluidly coupled to the saltwater transfer conduit and that is configured to (a) receive and adsorb water from air previously humidified by the saltwater, and (b) release bound water upon heating with heat. In such cases, it is preferred that the metal oxide framework unit will be configured to receive the heat from the heliostat.

Viewed from another perspective, and in another embodiment, the inventors have contemplated a method of manufacturing hydrogen gas, the method comprising the step of conveying water from a water source to a primary desalination reactor via a water transfer conduit, wherein the water transfer conduit has a luminal surface that comprises a super-hydrophobic coating, then using a heliostat to provide energy to the primary desalination reactor and a hydrogen generating reactor, and using an electrode in the hydrogen generating reactor and the energy from the heliostat to electrochemically generate hydrogen gas from the water, wherein the electrode comprises a super-hydrophilic material. Further, it is contemplated that in some embodiments, at least some of the hydrogen gas is trapped in the water, and the water with the trapped hydrogen gas is passed over a surface comprising a super-hydrophobic material to thereby expel the trapped hydrogen gas from the water. Still further, the inventors contemplate that the energy provided by the heliostat to the primary desalination unit is thermal energy, and wherein the energy provided by the heliostat to the hydrogen generating reactor is electrical energy.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts an exemplary desalination plant according to the inventive subject matter.

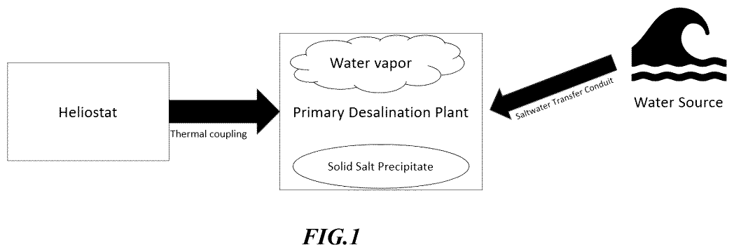

FIG. 2 depicts an exemplary desalination plant used to extract lithium according to the inventive subject matter.

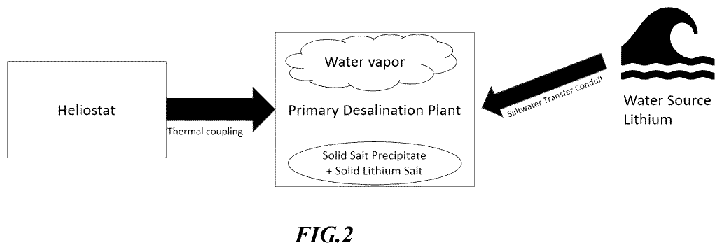

FIG. 3 depicts an exemplary desalination plant used to manufacture hydrogen gas according to the inventive subject matter.

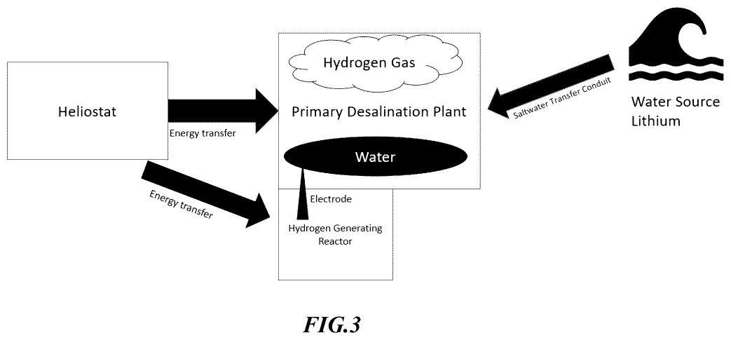

### DETAILED DESCRIPTION

The inventor has discovered that a desalination plant can be configured such that light energy will be used to continuously desalinate saltwater, and especially saltwater that is or is derived from seawater or geothermal brine to so continuously produce a solid salt product and water vapor that can then be used as freshwater or working fluid in a power generator. As should further be appreciated, such desalination plant may be specifically configured to exclusively produce the water vapor and the solid salt product, or may be implemented in a plant configuration in which solar energy is also used to generate power (typically using heat transfer fluids in a Rankine cycle other than the saltwater), to produce gaseous hydrogen, or to produce a synthetic hydrocarbon.

For example, contemplated heliostat-based power production plants will include those that employ catalytic dissociation of water into molecular hydrogen and oxygen. As will be readily appreciated, such production plants may also include a molten salt heat storage and release system to so allow operation during periods of lower sun intensity and/or at night as is exemplarily described in US 2020/0095122, incorporated by reference in its entirety herein. Likewise, suitable heliostat systems include those that allow carbon-neutral fuel production from aragonite as described in U.S. Ser. No. 17/873,995, also incorporated by reference in its entirety herein. In still further contemplated aspects, desalination systems may also be configured as described in WO 2019/053638 in which graphene is used as photothermal material to absorb light in a light-receiving structure and to so convert light energy to thermal energy via non-radiative decay. Further design considerations for solar desalination units suitable for use herein are described elsewhere (International Journal of Chemical Engineering, Volume 2017, Article ID 5924173).

Therefore, the inventor contemplates a desalination plant that includes a primary desalination reactor that is fluidly coupled to a saltwater source by a saltwater transfer conduit. Most typically, but not necessarily, the saltwater source may be an ocean or estuary with brackish water, and the saltwater transfer conduit will transfer the saltwater to the primary desalination reactor over a distance of at least several miles to a location where a heliostat is located. On the other hand, where the saltwater source is a geothermal feature (natural geothermal spring, artificial well, etc.), the saltwater transfer conduit may have a length that is significantly less.

Therefore, contemplated saltwater transfer conduits may have a length of at least 100 m, or at least 250 m, or at least 500 m, or at least 1 km, or at least 5 m, or at least 50 km, or at least 100 km, or at least 200 km, and may therefore include one or more pump stations to maintain fluid flow across significant distances (and even to a location having a higher altitude than the saltwater source. Thus, the saltwater transfer conduits may have a length of between 100 m and 500 m, or between 500 m and 2 km, or between 2 km to 10 km, or between 10 and 100 km, and even longer.

As will be readily appreciated, the saltwater from most, if not all saltwater sources will contain in addition to single ionic species (e.g., Na⁺, Cl⁻) numerous inorganic compounds such as nitrates, sulfates, phosphates, etc., which will contribute to microbial growth that ultimately leads to biofilm formation, microbial contamination (elevated bacterial count of pathogens and non-pathogens), and microbial fermentation products (e.g., H₂S, CO₂, butyrate, etc.), which may additionally lead to an increased chemical and/or chemical oxygen demand. Such contamination is therefore undesirable and will render most downstream uses problematic or even impossible, especially where the products of the downstream process should have a desirable degree of chemical purity. In this context it should be noted that certain self-cleaning surfaces in light-driven desalination plants have been described (see CN106629945). Here, self-cleaning is achieved by use of certain photocatalyst (ZnO, TiO₂, and Al₂O₃) nanoparticles that generate reactive radical species to so destroy various contaminant. However, such systems require significant quantities of incident light, which is typically not available for pipes and other seawater conducting structures.

To overcome such difficulties, the inventor has now discovered that when the saltwater transfer conduit has a luminal surface that comprises a super-hydrophobic coating, microbial growth and surface fouling can be significantly reduced, if not entirely avoided. In preferred aspects of the inventive subject matter, the super-hydrophobic coating will result in a contact angle with water of at least 140°, or at least 145°, or at least 150°, or at least 152°, or at least 155°, or at least 158°, or at least 160°. To that end, it is contemplated that the luminal surface of the saltwater transfer conduit will comprise or be coated with a super-hydrophobic material. Among other suitable choices, the super-hydrophobic material may comprise graphene or a chemically modified graphene. It is further contemplated that the super-hydrophobic coating may reduce the likelihood of clogging in the conduit and/or any other channels by preventing the accumulation of salt and/or other particles present in water, providing smoother and more reliable flow, and reducing the maintenance required over time. The superhydrophobic material may further offer protection against the gradual deterioration of the primary desalination reactor and/or the conduit, shielding them from the erosive effects of exposure to flowing water or brine over time.

For example, where the graphene is unmodified, it is generally preferred (but not necessarily required) that the graphene is a few-layer graphene having between 1 and 10, or between 5 and 20, or between 25 and 50 graphene planes. Such materials can be produced from a variety of sources using processes well known in the art (e.g., starting from graphite flakes that are then subjected to a pyrolytic shock with or without intercalated oxidizers). In addition, it should be noted that graphene and/or the source material graphite, can be chemically oxidized to form graphite oxide and graphene oxide, which has also been demonstrated to have high hydrophobicity (see e.g., Adv. Mater. 22, 2151-2154 (2010)). On the other hand, where the graphene is modified, the modified graphene may be produced in a process that intercalates one or more types of metal oxide nanoparticles, and especially Fe₃O₄ nanoparticles (see e.g., RSC Adv., 2019, 9, 16235), or hydrophobic moieties can be covalently attached to the oxide groups of graphene oxide and especially few-layer graphene oxide. For example, graphene oxide can be further modified using octadecylamine to form a superhydrophobic graphene surface (see e.g., Langmuir 26, 16110-16114 (2010)). In still other known methods of making superhydrophobic graphene, vinylidene fluoridehexafluoropropylene (PVDF-HFP) can be combined with graphene (see e.g., Langmuir 27, 8943-8949 (2011)). Similarly, superhydrophobic composites can also be made from a combination of micronized graphene and PVDF. In still further known composite materials, graphene and 2-methoxy-5-(20-ethyl-hexyloxy)-1,4-phenylene vinylene (MEH-PPV) particles can be combined to so form superhydrophobic composites (see e.g., Carbon 50, 216-224 (2012)).

In some embodiments, the superhydrophobic graphene materials are combined with a paint or other carrier system such as various resins or polymers to facilitate application to the luminal surface of the conduit. On the other hand, it should also be appreciated that the superhydrophobic materials may be directly formed on the luminal surface (or a carrier sheet that will be coupled to the luminal surface to form a laminate), typically via microwave plasma chemical vapor deposition. Such process is particularly advantageous as it produces few-layer graphene on a variety of materials (see e.g., Carbon 45, 2229-2234 (2007)). Moreover, the graphene planes in such few-layer graphene will often be vertically oriented, resulting in very high contact angles. In addition to self-cleaning and antimicrobial properties of such conduits, it should also be appreciated that the so treated conduits will have a significantly reduced tendency to corrode (and especially reduced tendency to electrochemical oxidation due to high salinity). Consequently, it should be appreciated that the conduits presented herein will be especially advantageous for transport of saltwater that can support growth and colonization of microbial life. As such, long-distance transport of water from coastal areas to sun-exposed areas will be viable without substantial pre-treatment of the saltwater.

Depending on the type and rate of water removal from the water source, it is contemplated that some pretreatment may be desired to remove particulates that may otherwise lead to settling within the pipework. Therefore, the inventor contemplates one or more a solids reduction units that are fluidly coupled between the saltwater source and the primary desalination reactor. Among other choices, suitable solids reduction units will include basket filters or hydrocyclones for relatively coarse solids (e.g., algae, seaweed, sand, or other relatively large particles), a flow-through centrifuge, Tesla valve, or cross flow filtration unit for reduction or prevention of smaller particles (e.g., less than 2 mm in largest dimension but larger than microbial cells), and even cloth or membrane filters for removal of particles, cells, and spores in the micron size range.

Moreover, where desired, it is also contemplated that the plant may also include a sterilization unit that is fluidly coupled to the conduit to allow sterilization or viable cell count reduction. For example, such sterilization unit may comprise a unit that takes advantage of excess heat or radiation from the heliostat. Consequently, the sterilization unit may comprise a heating unit that heats the saltwater (at ambient or elevated pressure) and/or a UV irradiation unit that uses a portion of the UV light captured by the heliostat. On the other hand, the sterilization unit may also operate independently of the heliostat and may therefore be configured as an ozone or chlorine sterilization unit.

With respect to the heliostat that is thermally coupled to the primary desalination it is contemplated that all known heliostat configurations are deemed suitable so long as they provide sufficient solar energy to evaporate at least some of the saltwater. Therefore, suitable heliostats will provide thermal energy in an amount sufficient to generate from saltwater of the saltwater source a water vapor fraction and a solid salt precipitate. For example, collection areas for contemplated heliostats will have at least 10 m², or at least 100 m², or at least 200 m², or at least 500 m², or at least 1,000 m² of collection area for solar energy. Most typically, the collected solar energy will be concentrated onto a single reactor, but it should be appreciated that the collected solar energy may also be concentrated into a linear conduit that runs along a focal point of a mirror assembly. Moreover, and depending on the particular plant design, the concentrated or collected solar energy may be directed into the saltwater or into a heat transfer fluid that will then evaporate the water from the saltwater.

Regardless of the particular configuration of the heliostat, it is typically preferred that the primary desalination reactor will be configured to allow continuous feeding of the saltwater into and continuous withdrawal of the water vapor and the solid salt precipitate from the primary desalination reactor. Therefore, especially contemplated primary desalination reactors include those that employ a spray-dryer, which may be configured as a vacuum spray dryer (e.g., Desalination Volume 404, 17 Feb. 2017, Pages 182-191) or as a conventional counter current spray drier that uses heated air to evaporate the water from the salt, which will then continuously precipitate form the spray dry chamber (see e.g., U.S. Pat. No. 6,699,369). In such spray-dry operations, it is generally contemplated that the evaporation will be assisted at least in part be using heat from the heliostat to pre-heat the feed saltwater into the desalination reactor and/or by using heat from the heliostat in the desalination reactor.

In further contemplated embodiments, the desalination reactor may be configured as a tube-type evaporator (e.g., tube-in-shell, tube-in-tube, etc.), a falling film evaporator, a plate evaporator, or a basket evaporator, or any other type of evaporator that allows to (preferably continuously) evaporate water steam from the seawater and to produce solid salt precipitate. Heat may be provided in such and other cases directly from the heliostat (e.g., via a heated air stream or direct illumination) or indirectly via a heat transfer fluid that was previously heated by the solar energy received by the heliostat. Therefore, heat may also be provided via a heat storage medium (e.g., molten salt), or form a waste heat stream of a process stream associated with the operation of the heliostat.

Therefore, while use of heat from a heliostat is typically preferred, it should also be recognized that numerous heat sources in addition to or as alternative to solar heat are also deemed suitable. In some embodiments, the heat may be geothermal heat or waste heat from a large-scale industrial process such as hydrocarbon processing, smelting operations, glass or ceramics manufacture, or gasification of municipal waste. In other embodiments, the heat may also be derived from a variety of industrial exothermic processes, and especially from sulfuric acid production or radioactive waste storage.

In yet further contemplated aspects, the sweater may also be heated directly in a conduit that received the collected and concentrated solar radiation. In such case, the desalination reactor may be configured as a quartz (or otherwise transparent) conduit that receives the seawater (typically in an intermediate position and that discharges the solid salt at one end and the water vapor on the other. Additionally, it is contemplated that at least some of the heat from the heliostat may be used to generate a pressurized saltwater stream that can then be subjected to a membrane filtration process. Among other suitable membrane filtration processes, reverse osmosis filtration is particularly preferred. However, graphene-based membrane desalination processes are also expressly contemplated herein, and suitable graphene type membranes are known in the art (see e.g., RSC Adv., 2021, 11, 7981).

As will be readily appreciated, the evaporation process can be operated at an elevated pressure and as such will produce a compressed steam product that can then be decompressed in a steam turbine to produce power. Alternatively, the desalination can be performed at substantially ambient pressure. Regardless of the pressure, it should be recognized that the evaporation process will produce a continuous stream of purified (distilled) water steam that will typically be condensed in one or more condensers to yield a clean water stream for disposal, rerouting to a geothermic formation, feeding into an aquifer, or domestic clean water source.

Where water is evaporated in a distillation unit or membrane filtration unit and so leads to a concentrated brine fraction, it is contemplated that the brine can be further processed (in a batch or continuous fashion) using residual heat form the heliostat or heat transfer fluid to further desiccate the brine and produce the solid salt product.

In still further contemplated aspects, a metal oxide framework unit may be fluidly coupled to the saltwater transfer conduit and configured to receive and adsorb water from air previously humidified by the saltwater, and further configured to release bound water upon heating with heat that is typically provided by the heliostat. For example, in some embodiments the saltwater transfer conduit may be configured to include a head space (and optionally intermittent baffles to agitate the saltwater) above the water level in the conduit. Thusly produced humidified air can then be periodically withdrawn and routed through a metal oxide framework unit that absorbs the water in the framework. Upon saturation with water, the metal oxide framework unit is then heated (preferably using heat from the heliostat or other ambient heat or waste heat) to release the bound water and so regenerate the metal oxide framework in the metal oxide framework unit to so operate as a secondary desalination reactor.

Alternatively, the primary desalination reactor may be supplemented, or even replaced by a large-scale metal oxide framework unit (e.g., configured as a absorber tower) that receives humidified air, where the humidified air is produced by heating the saltwater. In such configuration, it should be appreciated that the evaporation of water from the saltwater does not need to be complete. Consequently, such configuration may use any waste heat stream that is present in heliostat system or may use only a fraction of the collected solar energy for generation of the humidified air. The resultant brine may then be routed to an evaporation pond or be further heated with solar energy to produce a dry salt product. There are numerous metal oxide framework materials known in the art, and all of them are deemed suitable for use herein (see e.g., ACS Cent. Sci. 2020, 6, 1348-1354, incorporated by reference in its entirety herein).

In a still further aspect, the inventor contemplates that the saltwater source may be lithium-rich. Saltwater may be lithium-rich when it contains more than 1 mg Li/kg of seawater, or 1 ppm. It is therefore contemplated that the solid salt precipitate generated from the saltwater source comprises a lithium salt. When saltwater, whether lithium-rich or lithium-poor, is conveyed into a primary desalination reactor via the saltwater transfer conduit, the thermal energy provided to the primary desalination reactor by the heliostat may generate from the saltwater the water vapor and a solid salt precipitate which comprises lithium. Most typically, the lithium salt may be lithium oxide, lithium sulfate, lithium chloride, lithium hydroxide, and/or lithium carbonate.

Further, although the lithium concentration in seawater is lower than that of lithium-rich water sources (such as lithium-rich geothermal brines), the inventors contemplate that seawater and/or lithium-rich water sources may be suitable water sources for the extraction of lithium. Consequently, contemplated systems and methods will not only allow for generation of potable water or water suitable for crop irrigation, but also produce secondary value products such as lithium salts that can be further refined to produce battery-grade lithium salts.

In other embodiments, the inventor contemplates a method of manufacturing hydrogen gas. In one typical example, a method may comprise a step of conveying water from a water source to a primary desalination reactor via a water transfer conduit, wherein the water transfer conduit has a luminal surface that comprises a super-hydrophobic coating. Such coating will advantageously reduce fouling and/or clogging of the pipes and may even reduce energy requirements for pumping due to reduced friction. A heliostat is then used to provide energy to a primary desalination reactor and a hydrogen generating reactor. In further typical examples, the hydrogen generating reactor will use an electrode for water dissociation and will use energy from the heliostat to drive electrochemical generation of hydrogen gas from the water. Most preferably, the electrode comprises a super-hydrophilic material. It is contemplated that the electrical current provided by the electrode supports electrolysis of water to generate hydrogen gas and oxygen gas. Advantageously, where the electrode comprises a super-hydrophilic material, water contact with the electrode is enhanced in the presence of evolving gas due to the substantially increased contact angle of the water with the super-hydrophilic material. As will be readily appreciated, the electrode may be partially or wholly made from a super-hydrophilic material, or the electrode may be coated with a super-hydrophilic coating. Examples of especially suitable super-hydrophilic materials include super-hydrophilic graphene, such as graphene that is chemically modified with polar groups. Among other examples, super-hydrophilic graphene includes graphene oxide (which may be used as bulk material or as electrospun fiber), oxidized graphene, hydroxylated graphene, graphene modified with carboxylate groups, etc.

In further embodiments, and depending on the rate of hydrogen production, it is contemplated that the hydrogen gas may be trapped as microbubbles. For example, while much of the hydrogen and oxygen gas may quickly escape the water upon electrolysis, some hydrogen and oxygen gas may be unable to overcome the surface tension of the water, thereby forming small bubbles that remain contained under the surface of the water. Therefore, the inventors contemplate that residual water, typically after passing through the hydrogen generating reactor, may be passed over a surface comprising a super-hydrophobic material to thereby expel the trapped hydrogen gas from the water. While not wishing to be bound by any theory or hypothesis, the inventor contemplates that when the water contacts the superhydrophobic material, residual bubbles of hydrogen gas in the water may coalesce and overcome the surface tension of the water, thereby enhancing hydrogen recovery.

Further, it is contemplated that the energy provided by the heliostat to the primary desalination reactor is thermal energy. For example, the heliostat may provide thermal energy in the form of light directed directly to the saltwater while in other embodiments the heliostat is configured to provide heat from a heat transfer medium as the thermal energy to the saltwater. In such case, the heat transfer medium was previously heated by light collected by the heliostat. In still other embodiments, the heliostat is configured to provide heat from a heated air stream as the thermal energy. In such case, the heated air stream was previously heated by light collected by the heliostat or by a heat transfer medium that was previously heated by light collected by the heliostat. In further embodiments, the energy provided to the hydrogen generating reactor is in the form of electrical energy. In typical embodiments, such electrical energy is generated using the thermal energy provided to the primary desalination reactor by the heliostat.

In some embodiments, the numbers expressing quantities of ingredients, properties such as concentration, reaction conditions, and so forth, used to describe and claim certain embodiments of the invention are to be understood as being modified in some instances by the term “about.” As used herein, the terms “about” and “approximately”, when referring to a specified, measurable value (such as a parameter, an amount, a temporal duration, and the like), is meant to encompass the specified value and variations of and from the specified value, such as variations of +/−10% or less, alternatively +/−5% or less, alternatively +/−1% or less, alternatively +/−0.1% or less of and from the specified value, insofar as such variations are appropriate to perform in the disclosed embodiments. Thus, the value to which the modifier “about” or “approximately” refers is itself also specifically disclosed. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A desalination plant, comprising:
a primary desalination reactor fluidly coupled to a saltwater source by a saltwater transfer conduit, wherein the saltwater transfer conduit has a luminal surface that comprises a super-hydrophobic coating; and
a heliostat thermally coupled to the primary desalination reactor such that the heliostat provides thermal energy in an amount sufficient to generate from saltwater of the saltwater source a water vapor and a solid salt precipitate; and
wherein the primary desalination reactor is configured to allow continuous feeding of the saltwater into and continuous withdrawal of the water vapor and the solid salt precipitate from the primary desalination reactor.

2. The plant of claim 1, wherein the saltwater source is a seawater source or a geothermic brine source.

3. The plant of claim 1, wherein the saltwater source is lithium-rich.

4. The plant of claim 1, wherein the solid salt precipitate comprises a lithium salt.

5. The plant of claim 1, wherein the primary desalination reactor comprises a distillation unit, a spray-drying unit, or a membrane filtration unit.

6. The plant of claim 1, wherein the heliostat is configured to provide heat from a heat transfer medium as the thermal energy to the saltwater, wherein the heat transfer medium was previously heated by light collected by the heliostat.

7. The plant of claim 1, wherein the super-hydrophobic coating comprises graphene or a chemically modified graphene.

8. The plant of claim 1, further comprising a metal oxide framework unit fluidly coupled to the saltwater transfer conduit and configured to receive and adsorb water from air previously humidified by the saltwater, and further configured to release bound water upon heating with heat.

9. A method of removing salt from saltwater, comprising:
conveying saltwater from a saltwater source to a primary desalination reactor via a saltwater transfer conduit, wherein the saltwater transfer conduit has a luminal surface that comprises a super-hydrophobic coating; and
using a heliostat to provide thermal energy to the primary desalination reactor in an amount sufficient to continuously generate from the saltwater a water vapor and a solid salt precipitate; and
continuously withdrawing the water vapor and the solid salt precipitate from the primary desalination reactor.

10. The method of claim 9, wherein the saltwater source is a seawater source or a geothermic brine source.

11. The method of claim 9, wherein the saltwater source is lithium-rich.

12. The method of claim 10, wherein the solid salt precipitate comprises lithium.

13. The method of claim 9, wherein the primary desalination reactor comprises a distillation unit, a spray-drying unit, or a membrane filtration unit.

14. The method of claim 9, wherein the heliostat provides heat from a heat transfer medium as the thermal energy to the saltwater, wherein the heat transfer medium was previously heated by light collected by the heliostat.

15. The method of claim 9, wherein the super-hydrophobic coating comprises graphene or a chemically modified graphene.

16. The method of claim 9, further comprising a solids reduction unit fluidly coupled between the saltwater source and the primary desalination reactor.

17. The method of claim 9, further comprising a metal oxide framework unit fluidly coupled to the saltwater transfer conduit and configured to receive and adsorb water from air previously humidified by the saltwater, and further configured to release bound water upon heating with heat.

18. A method of manufacturing hydrogen gas, the method comprising:
conveying water from a water source to a primary desalination reactor via a water transfer conduit, wherein the water transfer conduit has a luminal surface that comprises a super-hydrophobic coating;
using a heliostat to provide energy to the primary desalination reactor and a hydrogen generating reactor; and
using an electrode in the hydrogen generating reactor and the energy from the heliostat to electrochemically generate hydrogen gas from the water, wherein the electrode comprises a super-hydrophilic material.

19. The method of claim 18, wherein at least some of the hydrogen gas is trapped in the water, and the water with the trapped hydrogen gas is passed over a surface comprising a super-hydrophobic material to thereby expel the trapped hydrogen gas from the water.

20. The method of claim 18, wherein the energy provided by the heliostat to the primary desalination unit is thermal energy, and wherein the energy provided by the heliostat to the hydrogen generating reactor is electrical energy.
